(19) United States
(12) Patent Application Publication
(10) Pub. No.: US 2015/0154665 A1
(43) Pub. Date: Jun. 4, 2015

(54) Plan Reader

(71) Applicant: Robert Martin, Seattle, WA (US)

(72) Inventor: Robert Martin, Seattle, WA (US)

(21) Appl. No.: 14/097,203

(22) Filed: Dec. 4, 2013

(51) Int. Cl. G06Q 30/02; G06K 9/00

(52) U.S. Cl. CPC G06Q 30/0278; G06K 9/00476

(57) ABSTRACT

The instant application discloses, among other things, ways to read a plan for a project and provide a list of components. This may be used, for example, to create a bill of materials for a building project, or a list of components for a circuit board. Any plan with distinctive marks identifying various component-types may be processed.

### FIELD

This disclosure relates generally to a Plan Reader.

### BACKGROUND

Architects and engineers designing buildings or infrastructures such as electrical; heating, ventilation, and air conditioning (HVAC), or plumbing systems, often generate plans or blueprints showing the components required. When these plans are sent to contractors to obtain price bids, it is often necessary to review the plans and count each of the components to produce a bill of materials for the job to produce a quote. In some cases, a similar process may be used by a supplier asked to provide pricing.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, techniques to provide for Plan Reader. In one embodiment, a plan or blueprint for a project may be scanned, with software analyzing the resulting digital image to identify symbols representing various components or component types used. These symbols may be matched with known symbols from previous projects, from a legend on the plan, or manually. In one embodiment, a specification may identify particular requirements or part numbers desired for the project. A bill of materials (BOM) may be produced. In one embodiment, Plan Reader may integrate with a supplier's or manufacturer's catalog to identify components meeting specifications, and provide a price estimate. Plan Reader may be implemented on a distributed system or on a single computer.

Many of the attendant features may be more readily appreciated as they become better understood by reference to the following detailed description considered in connection with the attached drawings.

### BRIEF DESCRIPTION OF THE DRAWINGS

The instant application discloses, among other things, techniques to provide for a Plan Reader. In one embodiment, a plan or blueprint for a project may be scanned, with software analyzing the resulting digital image to identify symbols representing various components or component types used. These symbols may be matched with known symbols from previous projects, from a legend on the plan, or manually. In one embodiment, a specification may identify particular requirements or part numbers desired for the project. A bill of materials (BOM) may be produced. In one embodiment, Plan Reader may integrate with a supplier's or manufacturer's catalog to identify components meeting specifications, and provide a price estimate. Plan Reader may be implemented on a distributed system or on a single computer.

The present description may be better understood from the following detailed description read in light of the appended drawings, wherein:

FIG. 1 is a system capable of supporting Plan Reader according to one embodiment.

FIG. 2 is a system capable of supporting Plan Reader according to another embodiment.

FIG. 3 illustrates an example of a portion of an electrical plan.

FIG. 4 is an example of an excerpt from an electrical specification, including some of the requirements for panels.

FIG. 5 is a flow diagram illustrating Plan Reader process to create a listing according to one embodiment.

FIG. 6 is illustrates a component diagram of a computing device according to one embodiment.

Like reference numerals are used to designate like parts in the accompanying drawings.

### DETAILED DESCRIPTION

A more particular description of certain embodiments of Plan Reader may be had by references to the embodiments shown in the drawings that form a part of this specification, in which like numerals represent like objects.

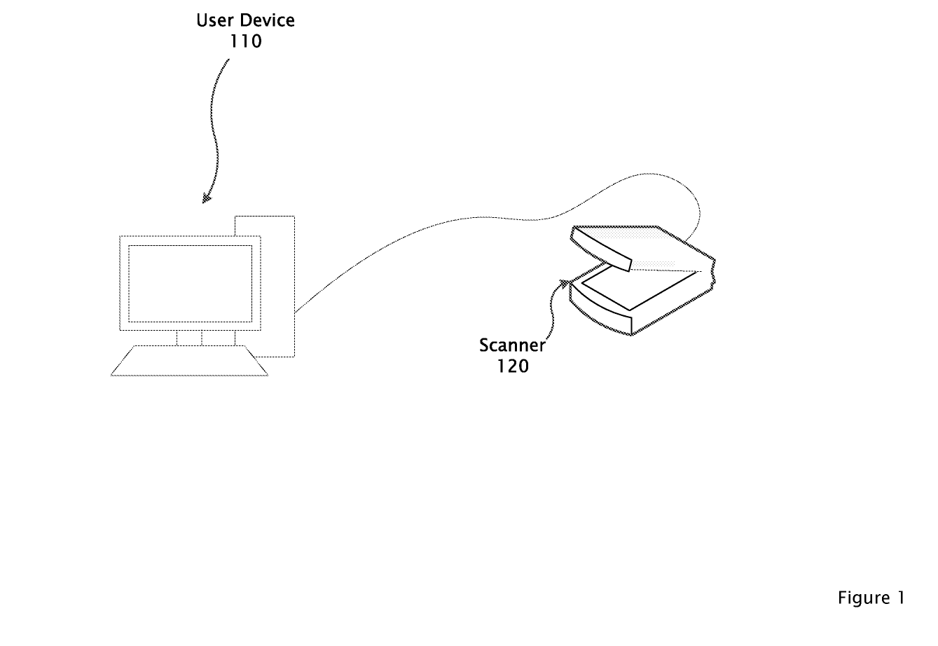

FIG. 1 illustrates a system capable of Plan Reader according to one embodiment. User Device 110 may include a processor, memory and computer readable storage media.

Scanner 120 may be a flatbed scanner, a digital camera, an all-in-one device, or any other device capable of capturing a digital image of a hard copy of a plan. A plan may be a plan for an electronic device, a blueprint for a construction job, or any other sort of graphical description of a project including components symbolized by marks on the plan.

User Device 110 may be used process a plan using a scan produced by Scanner 120. Software on User Device 110 may use pattern recognition or other techniques to identify components drawn on the plan by comparing the scanned image to known images, or by performing a mathematical analysis of the scan. Known images may be obtained from previous scans, from manufacturer or supplier catalogs, from images available from the Internet, or from other sources.

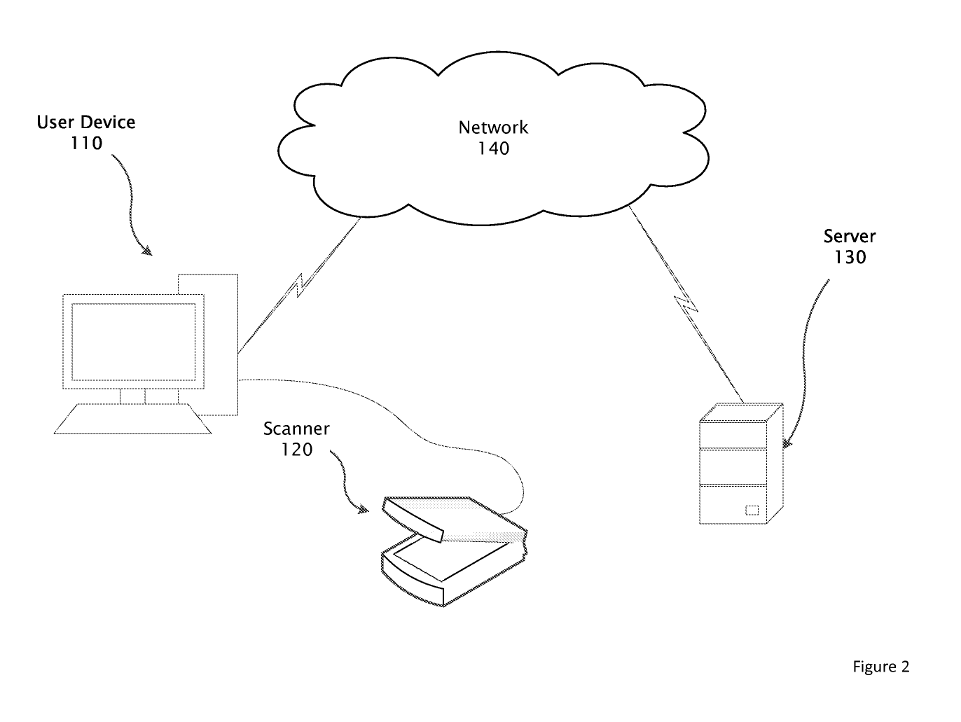

FIG. 2 illustrates a system capable of Plan Reader according to another embodiment. User Device 110 may include a processor, memory and computer readable storage media.

Network 140 may include Wi-Fi, cellular data access methods, such as 3G or 4GLTE, Bluetooth, NFC, the internet, local area networks, wide area networks, or any combination of these or other means of providing data transfer capabilities. In one embodiment, Network 140 may comprise Ethernet connectivity. In another embodiment, Network 140 may comprise fiber optic connections.

Server 130 may include one or more computers, and may serve a number of roles. Servers 130 may be conventionally constructed, or may be of a special purpose design for processing data for Plan Reader. One skilled in the art will recognize that Server 130 may be of many different designs and may have different capabilities.

Server 130 may host applications, data, or other information supporting Plan Reader. In one embodiment, for example, Server 130 may host a web site enabling a Plan Reader user to load a scanned image of a plan, and Server 130 may provide an analysis.

User Device 110 may be used to access information or programs on Server 130 related to Plan Reader. Such information or programs may include, for example, processing scanned images to create a bill of materials, provide a course of patterns for component recognition, and storage of scanned plans.

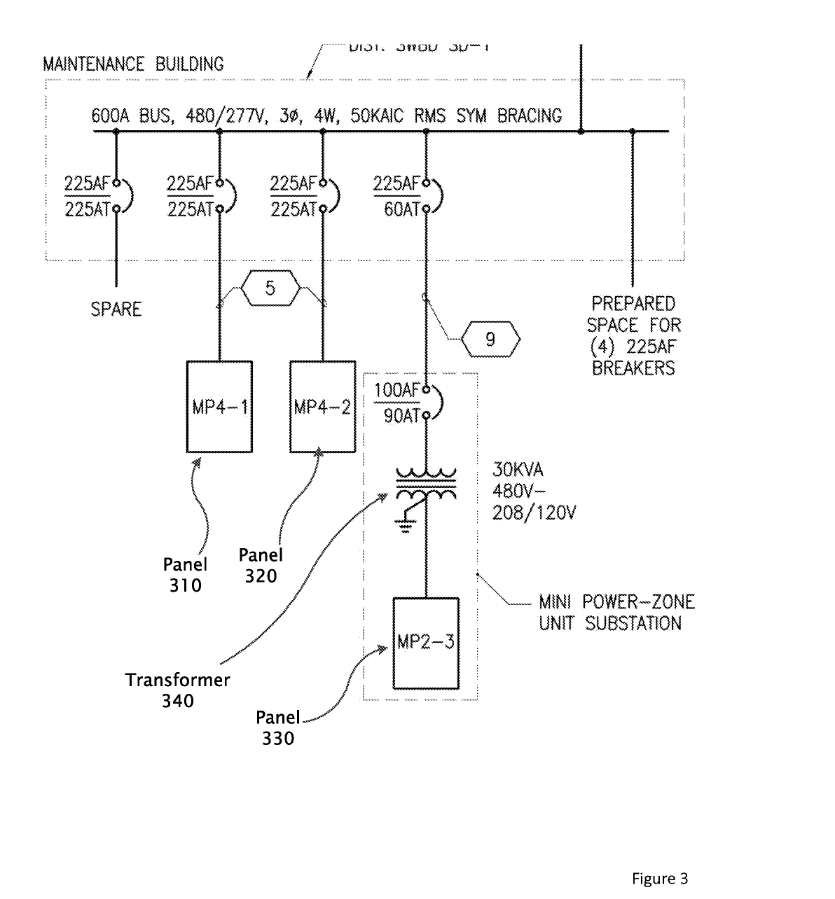

FIG. 3 illustrates an example of a portion of an electrical plan. In this portion, three electrical Panels 310, 320, 330, and a Transformer 340 are shown. Such a plan may be optically scanned or otherwise digitized to obtain a digital copy.

Plan Reader may recognize, using pattern recognition similar to optical character recognition, for example, the rectangles with lettering contained such as MP4-1 and MP4-2 as being electrical panels, and may provide a count of such devices on the overall plan. Plan Reader may be used to provide a BOM for buildings, electronic devices, automobiles, or any type of object for which there are plans containing distinctive marks for various types of components.

Plan Reader may use previously loaded information or mathematical analysis to identify components. For example, patterns may be stored in the program, in a database of component patterns, as mathematical formulae, or in other structures. In another embodiment, patterns may be read from a plan containing a legend of components used. In yet another embodiment, Plan Reader may recognize various components based on similar symbols, which may be manually matched to components after initial processing, so, for example, a list of patterns may be displayed to a user for identification. One having skill in the art will recognize that many different approaches may be used to providing pattern recognition abilities.

One having skill in the art will recognize that many different components, including electrical, plumbing, HVAC, structural, and other sub-assemblies or parts required to construct buildings, devices, or other objects, may be scanned and recognized.

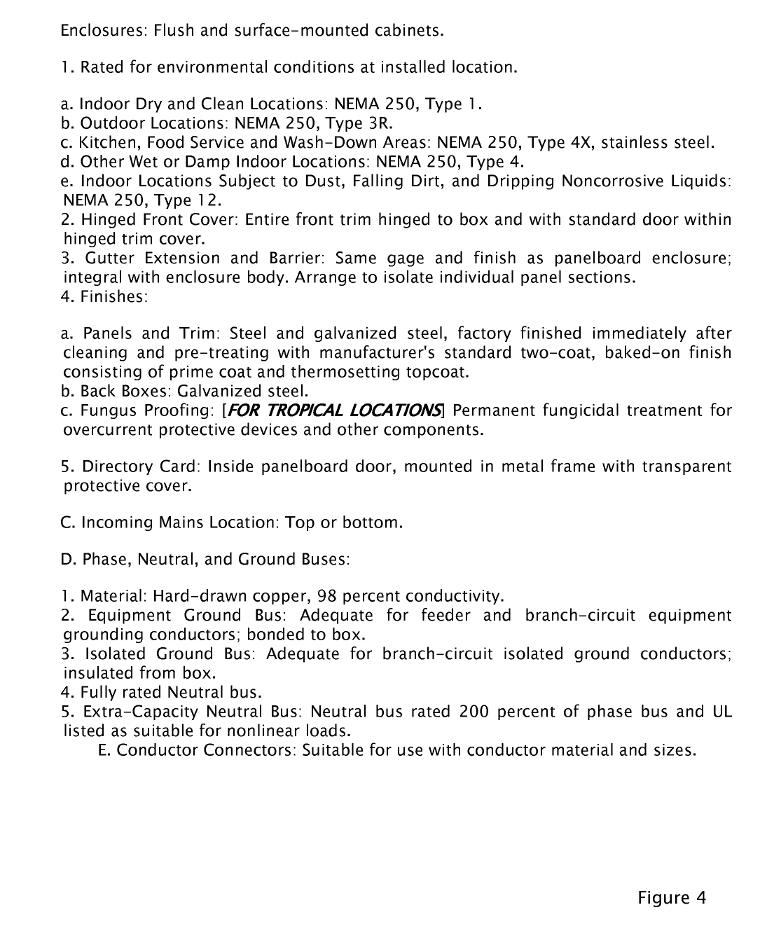

FIG. 4 is an example of an excerpt from an electrical specification, including some of the requirements for panels such as Panels 310, 320, 330. By entering these requirements in conjunction with a count of electrical panels obtained by using Plan Reader on plans as illustrated in FIG. 3 may allow a bill of materials (BOM) with requirements to be generated. The BOM with requirements may be provided to a contractor or supplier to obtain pricing for a job.

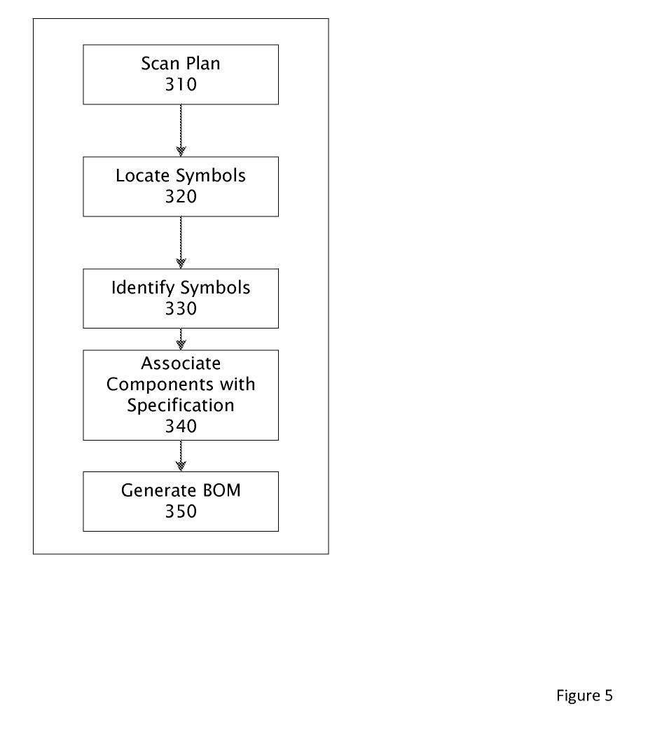

FIG. 5 is a flow diagram illustrating Plan Reader process to generate a bill of materials 350, according to one embodiment. A scanner, camera, or other device may be used to Scan Plan 310, to obtain a digital copy of the plan. The digital copy may then be analyzed to Locate Symbols 320. Located Symbols may be Identified 330, providing a list of components used on the plan. The Components may be Associated with a Specification 340, which may allow specific part numbers or the like to be obtained. This may allow a Bill of Materials to be Generated 350 for pricing and other estimating processes. The BOM may then be output in one or may ways, for example shown on a display, printer a printer, or sent via email. In another embodiment, the BOM may be combined with a supplier catalog to automatically provide a price quote or invoice. One having skill in the art will recognize that variations of this method may be used without varying from the spirit of the instant disclosure.

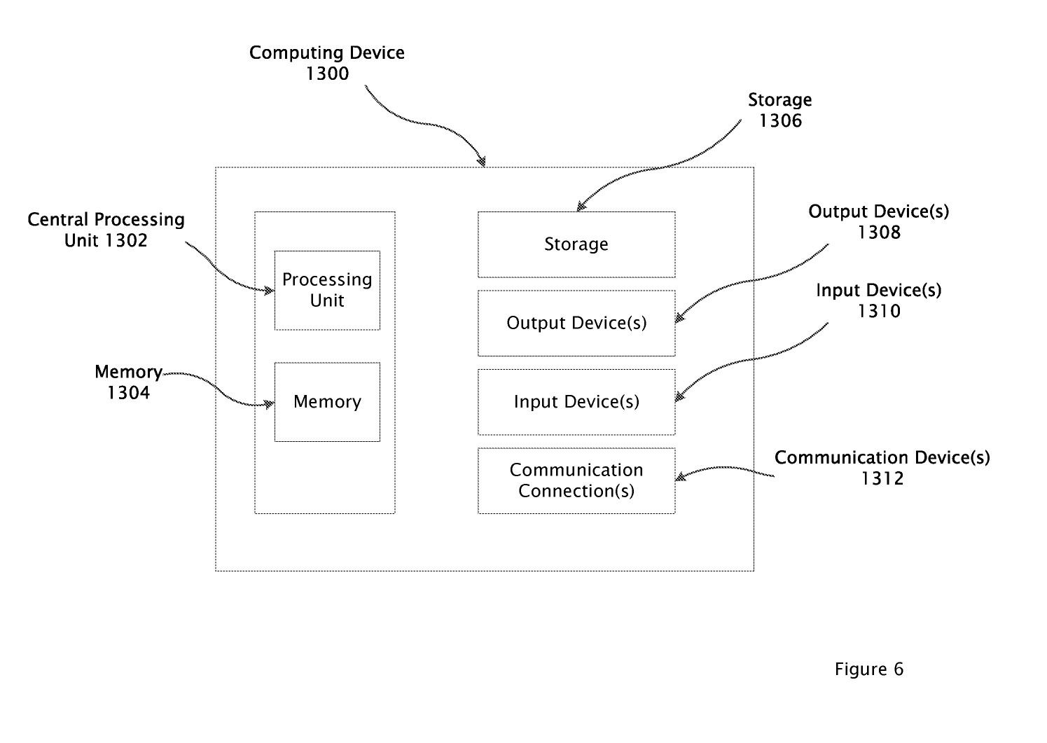

FIG. 6 is illustrates a component diagram of a computing device according to one embodiment. The Computing Device 1300 can be utilized to implement one or more computing devices, computer processes, or software modules described herein, including, for example, but not limited to a mobile device. In one example, the Computing Device 1300 can be used to process calculations, execute instructions, and receive and transmit digital signals. In another example, the Computing Device 1300 can be utilized to process calculations, execute instructions, receive and transmit digital signals, receive and transmit search queries and hypertext, and compile computer code suitable for a mobile device. The Computing Device 1300 can be any general or special purpose computer now known or to become known capable of performing the steps and/or performing the functions described herein, either in software, hardware, firmware, or a combination thereof.

In its most basic configuration, Computing Device 1300 typically includes at least one Central Processing Unit (CPU) 1302 and Memory 1304. Depending on the exact configuration and type of Computing Device 1300, Memory 1304 may be volatile (such as RAM), non-volatile (such as ROM, flash memory, etc.) or some combination of the two. Additionally, Computing Device 1300 may also have additional features/functionality. For example, Computing Device 1300 may include multiple CPUs. The described methods may be executed in any manner by any processing unit in computing device 1300. For example, the described process may be executed by both multiple CPUs in parallel.

Computing Device 1300 may also include additional storage (removable and/or non-removable) including, but not limited to, magnetic or optical disks or tape. Such additional storage is illustrated in FIG. 6 by Storage 1306. Computer readable storage media includes volatile and nonvolatile, removable and non-removable media implemented in any method or technology for storage of information such as computer readable instructions, data structures, program modules or other data. Memory 1304 and Storage 1308 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1300. Any such computer readable storage media may be part of computing device 1300. Computer readable storage media does not include transient signals.

Computing Device 1300 may also contain Communications Device(s) 1312 that allow the device to communicate with other devices. Communications Device(s) 1312 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 1300 may also have Input Device(s) 1310 such as keyboard, mouse, pen, voice input device, touch input device, etc. Output Device(s) 1308 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A plan reading system, comprising:
a processor;
memory operatively coupled to the processor;
components operable on the processor, comprising:
a digital plan receiving component, configured to receive a digital copy of a plan;
a pattern finding component, configured to locate a pattern of a component used on the plan;
a pattern identification component, configured to identify the located pattern;
an output component, configured to output the identified pattern.

2. The plan reading system of claim 1 further comprising a scanner component, configured to scan a hard copy image of a plan and provide a digital copy of the plan.

3. The plan reading system of claim 1 further comprising a bill-of-materials generating component, configured to generate a bill of materials from a plurality of identified patterns.

4. A method, comprising:
receiving a digital copy of a plan;
locating symbols on the plan associated with components;
identifying components associated with the located symbols; and
outputting a list of the components.

5. The method of claim 4, further comprising scanning a hard copy of a plan.

6. The method of claim 4, further comprising:
matching the identified components with a specification; and
outputting a bill of materials.

7. The method of claim 4, further comprising:
matching the identified components with a catalog; and
outputting a price quote.
